(19) United States
(12) Patent Application Publication
(10) Pub. No.: US 2012/0324446 A1
(43) Pub. Date: Dec. 20, 2012

(54) VIRTUAL MACHINE IMAGE COMPOSITION AND SIGNING

(75) Inventors: Robert Fries, Kirkland, WA (US); Ashvinkumar Sanghvi, Sammamish, WA (US)

(73) Assignee: MICROSOFT CORPORATION, Redmond, WA (US)

(21) Appl. No.: 13/163,612

(22) Filed: Jun. 17, 2011

(51) Int. Cl. G06F 9/455

(52) U.S. Cl. 718/1

(57) ABSTRACT

Techniques are described for composing virtual machine images, generating signatures thereof, and verifying virtual machine images. A virtual machine image may be generated by installing or inserting software to a base virtual machine image. A signature may be computed using hash values of blocks of the base virtual machine image; blocks of the base image that are unchanged need not be hashed to generate the signature. A copy of the new virtual machine image can be verified at a computer hosting virtual machines by computing hashes only for modified or new blocks (relative to the base image). Block verification can take place in the background when a virtual machine starts; all of the blocks are verified (hashed and compared) in some order, and at the same time, unverified blocks are verified on demand as needed by the virtual machine.

### BACKGROUND

Machine virtualization involves providing a layer of software, such as a hypervisor or virtual machine monitor, between the hardware of a computer and environments or virtual machines sharing the hardware. The virtualization layer manages execution of virtual machines, simulating a virtual hardware or machine environment for each virtual machine. Software such as an operating system executing within the virtual machine executes as though it were interfacing directly with the underlying hardware.

Most virtualization layer implementations recognize some form of virtual disk image format. A virtual disk image may be a specially formatted file on a filesystem accessed or managed by the virtualization layer. Examples of virtual disk image formats include the Virtual Hard Disk (VHD) file format, the Virtual Machine Disk (VMDK) file format, and the Open Virtualization Format (OVF), all described in detail elsewhere. A virtual disk image may be associated with a virtual machine. When that virtual machine starts up, the virtualization layer opens and reads the associated virtual disk image, simulating a physical machine (the virtual machine) booting and reading a hard disk (the virtual machine image).

Typically, the virtual disk image contains an installed operating system, sometimes called the guest operating system. The guest operating system begins executing when the virtual machine is booted. The virtual disk image may, like any hardware machine, contain a software stack, applications, management tools, etc. The state of the software executing in the virtual machine is maintained on the virtual disk image, just as a hard disk stores the state of software running directly on a physical machine; file writes, virtual memory, and so on being written to the image during execution of the virtual machine. Typically, when the virtual machine is suspended, stopped, restarted, etc., the state of the virtual machine is stored in the virtual disk image.

Virtual disk images function as actual hard disks. To contain a full complement of software (in particular a guest operating system) and to accommodate storage of new data used by the software running from the virtual disk image, the virtual disk image is often a relatively large file, perhaps on the order of 10s or 100s of gigabytes. Therefore, management tasks related to virtual disk images can require significant time and computation. For instance, computing a digital signature of a virtual disk image can be time consuming; to date, a hash function must be computed over the entire virtual disk image, one block at a time. Similarly, verifying a signature of a virtual disk image may require the same lengthy process of computing hashes for each block of the image. In an environment where it is desirable for virtual machines to be configured and deployed quickly, signing and verification can be problematic.

Techniques related to composing, signing, and verifying virtual disk images are discussed below.

### SUMMARY

The following summary is included only to introduce some concepts discussed in the Detailed Description below. This summary is not comprehensive and is not intended to delineate the scope of the claimed subject matter, which is set forth by the claims presented at the end.

Techniques are described for composing virtual machine images, generating signatures thereof, and verifying virtual machine images. A virtual machine image may be generated by installing or inserting software to a base virtual machine image. A signature may be computed using hash values of blocks of the base virtual machine image; blocks of the base image that are unchanged need not be hashed to generate the signature. A copy of the new virtual machine image can be verified at a computer hosting virtual machines by computing hashes only for modified or new blocks (relative to the base image). Block verification can take place in the background when a virtual machine starts; all of the blocks are verified (hashed and compared) in some order, and at the same time, unverified blocks are verified on demand as needed by the virtual machine.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows an example virtualization layer.

FIG. 2 shows processes and interactions of virtualization layer in relation to virtual machines and virtual machine images.

FIG. 3 shows an example format for a virtual machine image.

FIG. 4 shows an example of a guest file system that might be in the content portion of a virtual disk image.

FIG. 5 shows a tool for building or composing virtual machine disk images.

FIG. 6 shows a method of signing a virtual machine image built from a base virtual machine image (e.g., a golden image) and software installed on the base virtual machine image.

FIG. 7 shows a process for recomputing an image hash of a virtual machine image that is based on an image with a pre-computed signature.

FIG. 8 shows a process for recomputing an image hash (hash-VHD′) when new blocks have been inserted into a base image.

FIG. 9 shows a process for verifying a virtual machine image build from a base virtual machine image.

FIG. 10 shows another process for efficient virtual machine image verification.

### DETAILED DESCRIPTION

Embodiments discussed below relate to composing, signing, and verifying virtual disk images. Discussion will begin with an overview of virtualization technology including virtualization components such as hypervisors and how they use virtual disk images. Some details of virtual disk images will be explained. A general embodiment for composing virtual disk images will then be discussed, followed by various embodiments for signing virtual disk images and verifying signatures of virtual disk images.

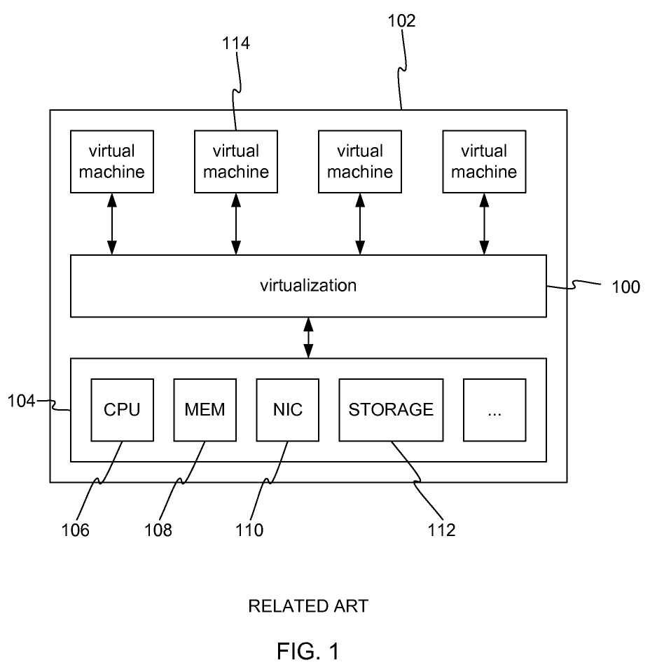

FIG. 1 shows an example virtualization layer 100. A computer 102 has hardware 104, including a central processing unit (CPU) 106, memory 108, a network interface 110, non-volatile storage 112, and other components not shown, such as a bus, a display adapter, etc. The virtualization layer 100 manages and facilitates execution of virtual machines 114. Although not shown in FIG. 1, each virtual machine 114 typically has an associated virtual disk image and a guest operating system. For brevity, the operating system and perhaps application software of a virtual machine 114 will sometimes be referred to as a guest, which is stored and executed from the virtual disk image associated with the virtual machine 114.

The virtualization layer 100 may be of any variety of known or future implementations, such as Hyper-V Server™, VMWare ESX Server™, Xen, Oracle VM™, etc. The architecture of the virtualization layer may a hosted type, with a virtual machine monitor (VMM) running on a host operating system, or a bare-metal type with a hypervisor or the like running directly on the hardware 104 of the computer 102. As used herein, the term “virtual machine” refers to a system-type virtual machine that simulates any specific hardware architecture (e.g., x86) able to run native code for that hardware architecture; to the guest, the virtual machine may be nearly indistinguishable from a hardware machine. Virtual machines discussed herein are not abstract or process-type virtual machines such as Java Virtual Machines.

The virtualization layer 100 performs the basic function of managing the virtual machines 114 and sharing of the hardware 104 by both itself and the virtual machines 114. Any of a variety of techniques may be used to isolate the virtual machines 114 from the hardware 104. In one embodiment, the virtualization layer may provide different isolated environments (i.e., partitions or domains) which correspond to virtual machines 114. Some of the virtualization layer 100 such as shared virtual device drivers, inter virtual machine communication facilities, and virtual machine management APIs (application programming interfaces), may run in a special privileged partition or domain, allowing for a compact and efficient hypervisor. In other embodiments, functionality for virtual machine management and coherent sharing of the hardware 104 may reside in a monolithic on-the-metal hypervisor.

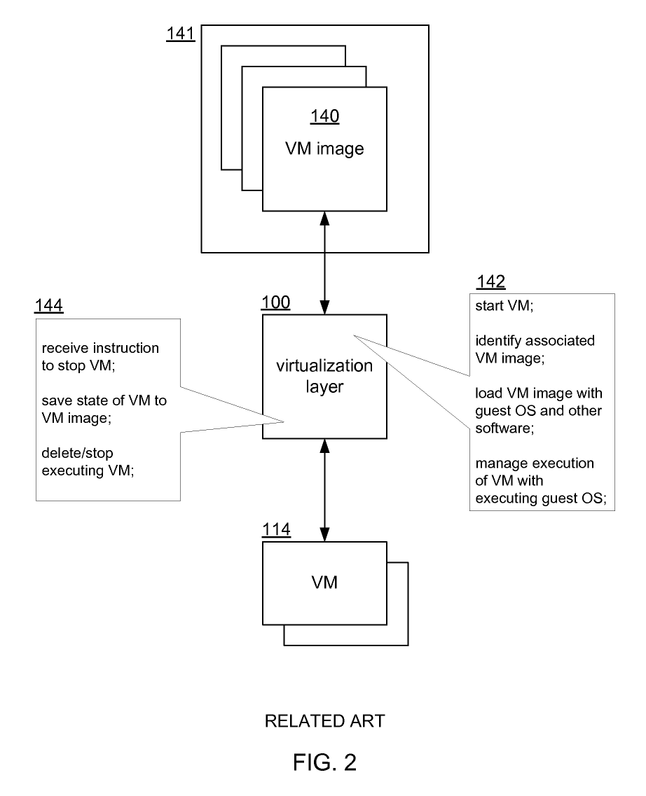

FIG. 2 shows processes and interactions of virtualization layer 100 in relation to virtual machines 114 and virtual machine images 140. The virtualization layer 100 performs a process 142 of starting and executing a virtual machine 114, possibly according to corresponding virtual machine configuration parameters. When a virtual machine 114 (VM) is started, the virtualization layer identifies an associated virtual machine image 140. In practice, any virtual machine image 140 can be used by any virtual machine 114. The virtual machine image 140 may be a specially formatted file (e.g., a VHD) on a file system 141 of the virtualization layer 100. The virtualization layer 100 loads the identified virtual machine image 140. The started virtual machine 114 mounts and reads the virtual machine image 140, perhaps seeking a master boot record or other boot information, and boots a guest operating system which begins executing.

The virtualization layer 100 manages execution of the virtual machine 114, handling certain calls to the guest's kernel, hypercalls, etc., and coordinating the virtual machine 114's access to the underlying hardware 104. As the guest and its software run, the virtualization layer 100 may maintain state of the guest on the virtual disk image 140; when the guest, or an application run by the guest, writes data to “disk”, the virtualization layer 100 translates the data to the format of the virtual disk image 140 and writes to the image.

The virtualization layer 100 may perform a process 144 for shutting down the virtual machine 114. When an instruction is received to stop the virtual machine 114, the state of the virtual machine 114 and its guest is saved to the virtual disk image 140, and the executing virtual machine 114 process (or partition) is deleted. A specification of the virtual machine 114 may remain for a later restart of the virtual machine 114.

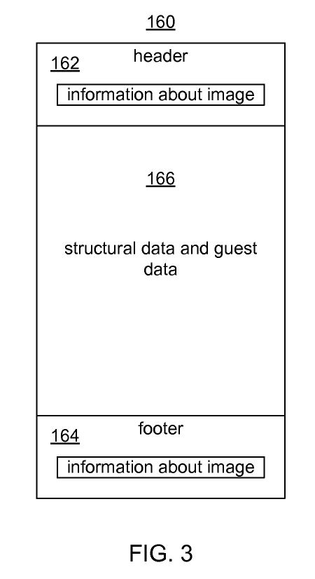

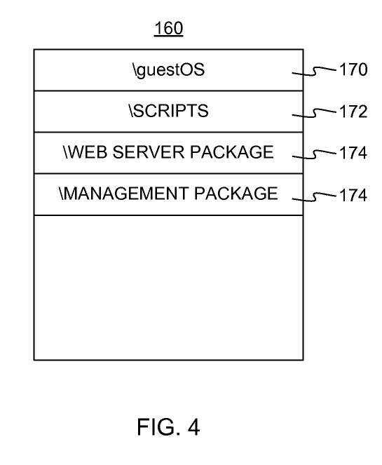

FIG. 3 shows an example format 160 for a virtual machine image. A header 162 and/or footer 164 may contain information about the virtual machine image. The information, for example, might comprise disk parameters or the size of blocks of the content 166 of the image, a header/footer checksum, an identifier for the image, information about a guest operating system in the content 166, a block allocation table, information for differencing (relating the image to differences thereof), and/or information to allow dynamic expansion of the virtual disk image. These are only examples. Detailed specifications of various virtual machine image file formats are available elsewhere. FIG. 4 shows an example of a guest file system that might be in the content 160 portion of a virtual disk image. In the example of FIG. 4, the content 160 includes an installed guest operating system 170, setup scripts 172 that might be run when the image is first booted, application or server software 174 of the guest in the virtual machine image, which might be either install packages or copies fully installed on the guest operating system.

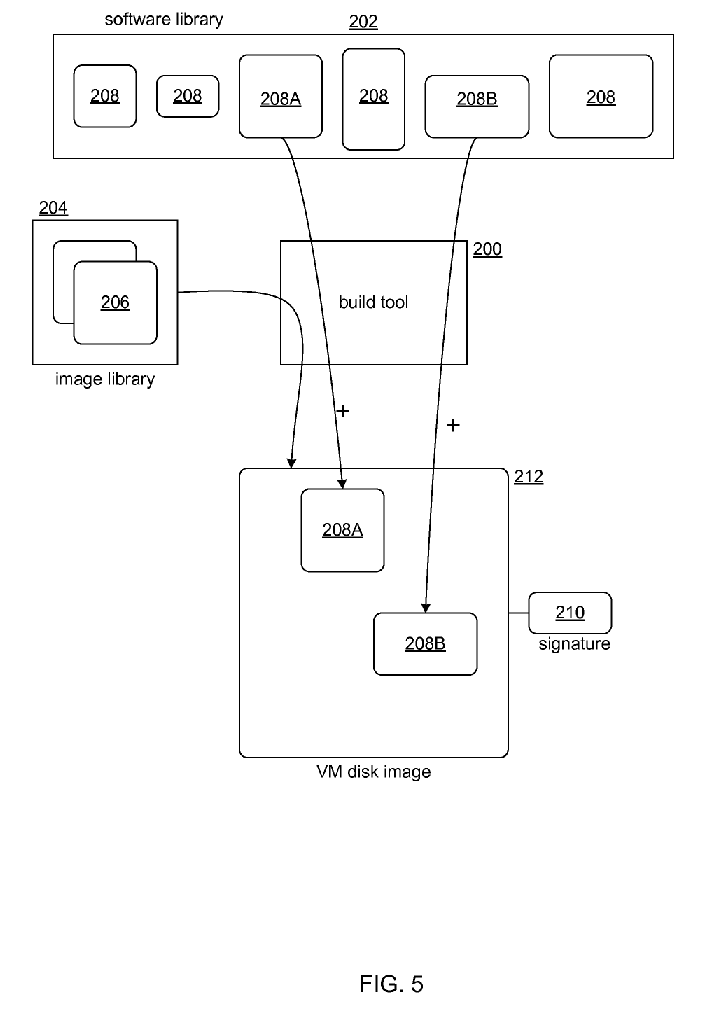

FIG. 5 shows a tool for building or composing virtual machine disk images. A build tool 200 is an application that executes on a development platform, for example. The build tool has access to a software library 202 and an image library 204. Images in the image library 204 may have associated signatures. The build tool 200 selects a base virtual machine image 206 from the image library 204 and software packages 208, as indicated by user input or otherwise. The build tool 200 copies the base virtual machine image 206, and installs the software packages 208. In addition, as will be described below, the build tool 200 computes a signature 210 of the new composite virtual machine image 212.

The image library 204 may contain various base virtual machine images 206, which are virtual machine images with a core of preinstalled software such as a guest operating system. Some of the images may be golden images, which are virtual machines with an operating system, perhaps a set of pre-configured services, software, settings, or other frequently deployed content. For instance, a golden image might be a database server or web server image that is ready to boot and begin executing.

The software library 202 may contain various software packages 208, such as a front-end server package, a database server package, a middleware package, management software for managing a node in a cloud, web servers, software updates, to name a few examples. The software packages may be in any of a variety of known installation formats or package formats. Some of the software packages may be simply a large install file that is installed only when the guest operating system is running in a virtual machine. Others may be files, directories, and configuration settings that are directly copied into the content (underlying file system) of the virtual machine image, possibly while the virtual machine image is mounted by the build tool 200.

The build tool 200 may compute a signature 210 of a newly built virtual machine image. As used herein, “signature” will refer to both a hash value (i.e., digest, fingerprint) as well as an encrypted hash value. It is known how to digitally sign a file. Commonly, when a file is to be signed, a hash is computed from the content of the file using a hash algorithm such as MD5, SHA 1 or 2. The hash value uniquely identifies the file, and any modification of the file can be detected by comparing a known or verified hash value with a hash value computed from the file to be verified; the computed hash value will differ from the verified hash value if the file has been modified. Encryption can be used to verify the hash value. When a signer signs a file, the hash value (digest) of the file is encrypted with the signer's private key. A verifier can use the signer's public key to decrypt the encrypted hash value. The decrypted (authenticated) hash value can then be compared to the verifier's computed hash value (e.g., digest) to determine if the file matches the original that was signed by the signer.

Virtual machine images, which are files, can be signed and verified as described above. If only data integrity is a concern an unencrypted signature (file hash) might be used, for example, to make sure that a copy is without errors. For security, encryption can be used to secure signatures. Computing a hash value from scratch for a large file is compute expensive as the entire file must be processed; the entire file must be evaluated by a possibly complex mathematical function. Once a hash or digest is computed, encryption thereof is relatively inexpensive. Therefore, the discussion herein focuses on hash related computation and assumes that encryption can be added in a straight-forward manner.

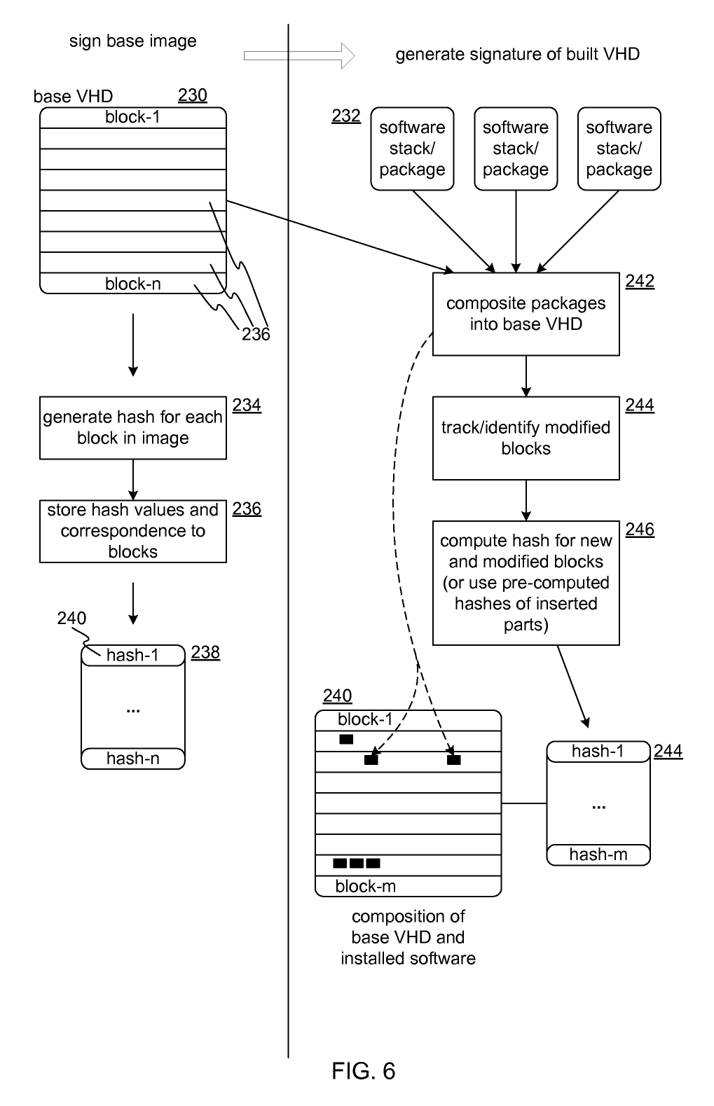

FIG. 6 shows a method of signing a virtual machine image built from a base virtual machine image 230 (e.g., a golden image) and software 232 installed on the base virtual machine image 230. In advance, the base virtual machine image 230 is signed. Specifically, at step 234 a hash is generated for each block 236 of the base virtual machine image 230. At step 236 a signature 238 is stored. The signature 238 may have a hash value 240 for each block 236, and optionally information linking the hash values 240 to the blocks 236. In one embodiment, the hashing may be done with a hash function that handles dynamic block sizes. Numerous existing hash algorithms may be used. Some such functions define cut points for blocks (of variable size) based on numerical properties of the hash values (e.g., local maxima). When data is inserted into the file, only hashes of affected blocks need to be recomputed (including new blocks when a block is chunked); many blocks and their hashes remain valid. When a piece of data is inserted, many if not most hash values need not be recomputed. For a detailed example, see the hashing algorithms discussed in “Optimizing File Replication over Limited-Bandwidth Networks using Remote Differential Compression”, Teodosiu et al., available online at microsoft.research.com. In general, rolling hashes may have similar advantages.

Returning to FIG. 6, when a new composited virtual machine image 240 is built, at step 242 the packages are inserted and/or installed into a copy of the base virtual machine image 230, thus forming the composited virtual machine image 240 (a version of the base virtual machine image 230). If a dynamically sized virtual disk format is used, then new blocks may be inserted. Whether a statically sized virtual disk format is used or a dynamically sided virtual disk format is used, various of the blocks of the base image may now differ from their original counterparts due to the newly inserted content. At step 244, the modified or inserted blocks are identified, and at step 246 hew hash values are computed for either the new blocks or the modified blocks. Hash values of unmodified or original blocks continue to be valid. The tracking/identifying at step 244 can be performed during step 242 when the software 232 is being inserted or installed.

In one embodiment, the signature or hash 238/244 may be stored within the image, as metadata in a header or footer. In another embodiment the hash 238/244 may be stored in an associated signature file.

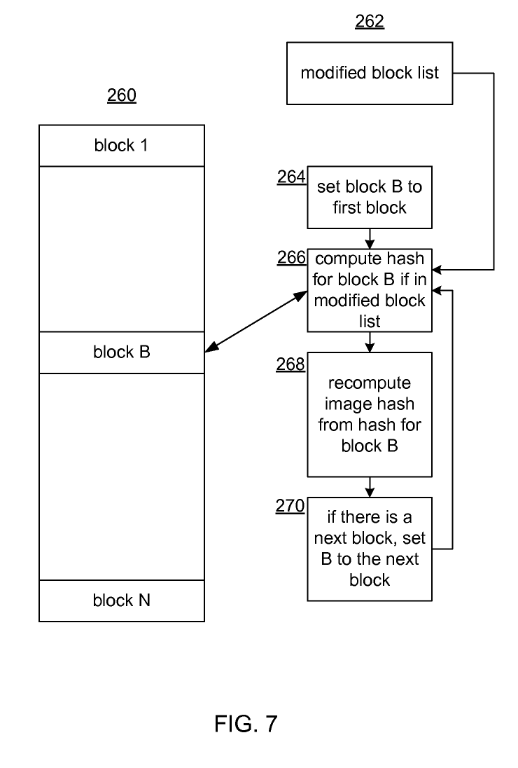

FIG. 7 shows a process for recomputing an image hash of a virtual machine image 260 that is based on an image with a pre-computed signature. In the example of FIG. 7, an image hash or signature is computed according to the hash of each block (i.e., hash_{image}=hash_{block-1}+hash_{block-2}+ . . . hash_{block-N}). A modified block list 262 indicates blocks modified or added by the addition of software to a base image. At step 264, enumeration over the blocks begins. At step 266, a hash value is computed for the current block B if it has been modified. At step 268, a new image hash is recomputed using the hash of the current block. In another embodiment, a hash algorithm is used that allows the new image hash to be computed from the image hash of the original base image and from the hash values of the modified blocks.

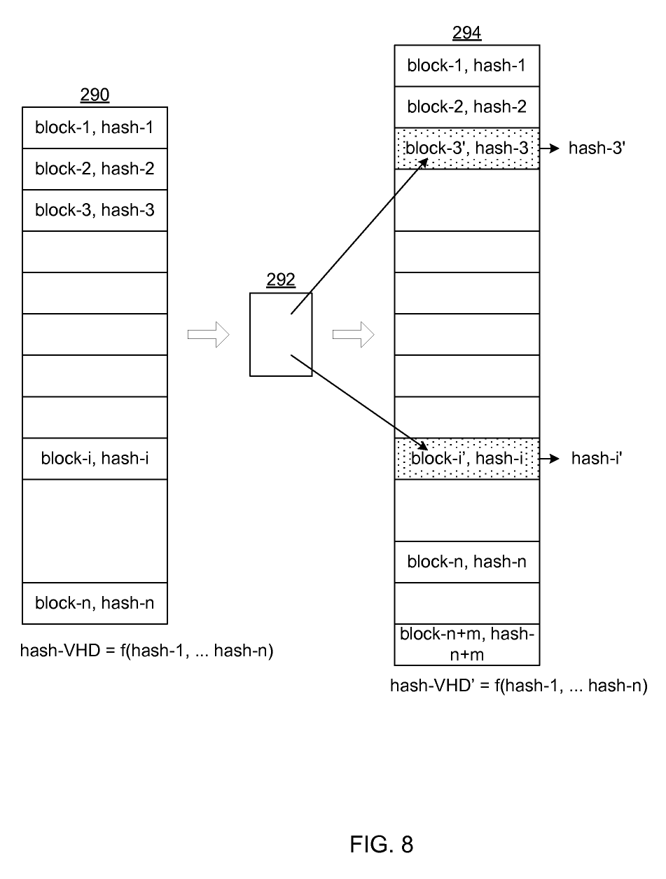

FIG. 8 shows a process for recomputing an image hash (hash-VHD′) when new blocks have been inserted into a base image 290. In this embodiment, it is assumed that there has been no tracking of changed blocks. A hash function, for instance a dynamic block size hash function 292 (as used in Remote Differential Compression (RDC), cited above), is used to identify new and/or modified blocks; as a hash window moves over the modified virtual machine image 294, new hashes (e.g., hash-3′, hash-i′) are computed. In one embodiment, a recursive hash function can be used to quickly identify modified regions. A resulting image hash may consist of the hash values of the respective blocks of the modified virtual machine image 294.

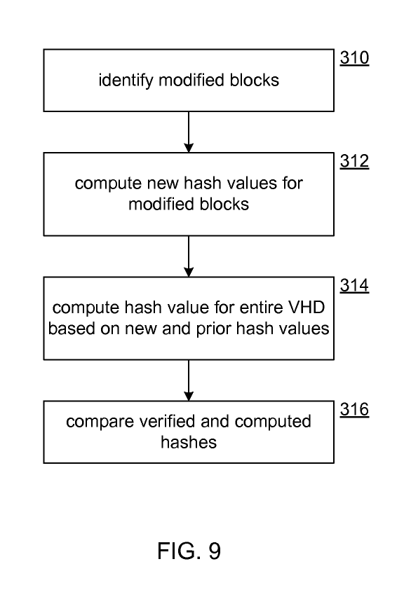

FIG. 9 shows a process for verifying a virtual machine image build from a base virtual machine image. It is assumed that the virtual machine image is accompanied by a known or authenticated hash of the entire virtual machine image, including hash values of blocks of the image. At step 310, a host with the virtual machine image (e.g., a server running a virtualization layer) identifies new or modified blocks in the virtual machine image. This may be accomplished by accessing a modified block list included with or within the virtual machine image. In another embodiment, a copy of the base virtual machine image and/or its signature are used to identify modified blocks. At step 312, new hash values are computed for the identified blocks.

At step 314 a hash value for the entire virtual machine image (e.g., VHD file) is computed using both the new hash values of the identified blocks, and using at least some of the hash values of the base virtual machine image (from its signature). If there are only small differences between the virtual machine image and its base virtual machine image, then most of the hash values used at step 314 may be obtained (from the base signature) without having to go through the costly process of reading each block in its entirety and computing a hash value for each block. If a relatively small portion of the blocks of the virtual machine image being verified are new/modified, then the hash value for the entire virtual machine image can be computed quickly.

At step 316, the virtual machine image is verified by comparing the computed hash (signature) with the hash (signature) received with the virtual machine image. As noted earlier, the verification may involve first decrypting the hash of the virtual machine image using a public key (matched to a private key that encrypted the hash), and comparing the decrypted hash with the computed hash. If they match, the authenticity and integrity of the virtual machine image have been verified.

Regarding the use of differencing disks, a differencing disk (described in detail elsewhere) has a parent image and modifications are captured in a chain of difference disks that only hold the delta blocks; the parent and difference disks together logically constitute a single coherent virtual disk. When running a VM from a chain of difference disks, the merging of the images to create a new updated image can also benefit from techniques described above. Each disk (parent disk or difference disk) travels with the signatures as described above. However, the difference disk has two composite image hashes, where one is the hash of all the hashes of the blocks it contains, and the other is the hash of all the composite image hashes in the chain from parent to itself. When verifying the merged image while running a VM therefrom, techniques similar to those discussed above may be used by: (A) checking to determine that the chain of image hashes verify (verifying that no difference image in the chain has been modified); (B) checking to see that the hash of block hashes of every disk in the chain (parent and difference disks) is consistent with the decrypted image hash; and (C) as the VM requires blocks from the chain, verifying the blocks as needed with hashes from the appropriate disks.

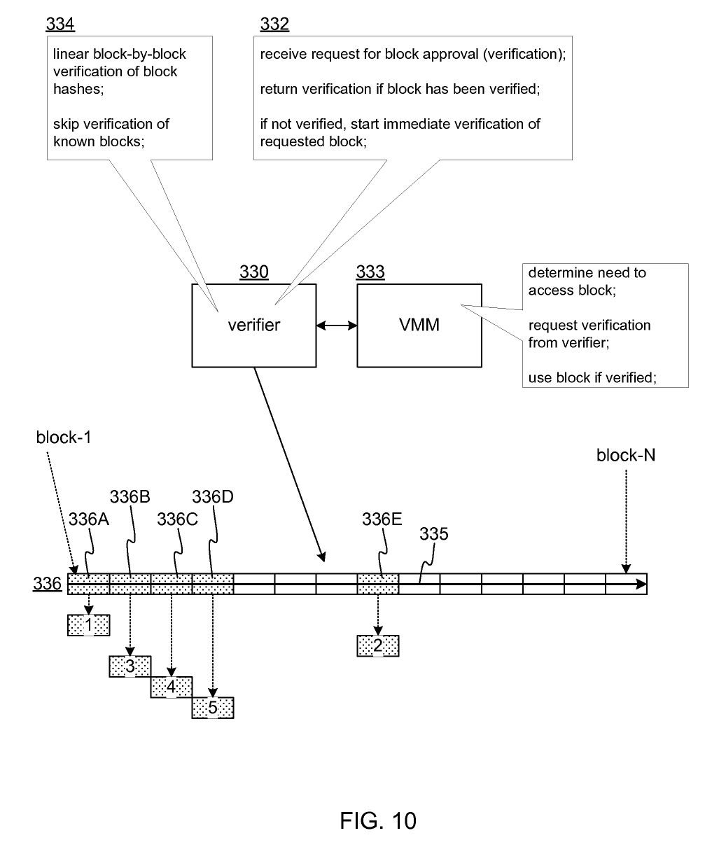

FIG. 10 shows another process for efficient virtual machine image verification. The process of FIG. 10 can be used in combination with techniques above, or the process can be used as a stand-alone technique when only an unverified virtual machine image and a known valid hash thereof are available. When a host receives the new virtual machine image and its hash, it is possible to begin executing that virtual machine image in a virtual machine immediately, while hash verification takes place in parallel. A verifier 330, which may be part of the virtualization layer, provides verification functions. A first process 332 verifies blocks as they are requested by the virtual machine (via virtual machine manager 333). For instance, the virtual machine receives a request for approval of a given block. The verifier returns approval for the block if it has previously verified the block. If the requested block has not been verified, the virtual machine blocks until the verifier 330 returns approval after hashing the block and comparing the block's hash to a known hash value (for instance, from the signature of the virtual machine image). While the virtual machine proceeds using paged-in verified blocks, a background process 334 proceeds with verifying blocks that have not yet been requested. Over time, all of the blocks are marked as verified. In this way, an unverified image can be used in a virtual machine immediately when it is received, and yet no unverified parts are used by the virtual machine. If each block is hashed before it is loaded, the signature of the entire image may be the signature that would have been computed from the image before being used by a virtual machine.

Referring to FIG. 10, background verification (process 334) is represented by line 335. Given a virtual machine image 336 with blocks 336A, 336B, 336C, 336D, and 336E, block 336A is verified first by process 334. The VMM 333 then requires block 336E and requests verification of the same; block 336E is verified second (hashed, and its hash value compared to the corresponding hash in the known signature). As the virtual machine proceeds using the content of blocks 336A and 336E, the background process 334 continues verifying blocks 336B, 336C, 336D, and so on.

In one embodiment, the verifier 330 executes as part of a virtualization management software stack executing in a privileged partition, and services requests from a microkernel hypervisor. In another embodiment, the verifier 330 executes directly in the hypervisor. The verifier 330 may have heuristics to perform background verification first on blocks most likely to be needed early by the virtual machine. For instance, boot related blocks, operating system related blocks, and others, can be identified by their content and given priority for verification.

Another embodiment may speed up hashing processes by using hardware acceleration, when available. Hardware acceleration may be in the form of an encryption chip, a Trusted Platform Module (TMP), a V-Chip, etc. In such a case, it is up to the VMM (virtual machine monitor) to take advantage of any hardware available on the host platform; hardware acceleration is transparent to the VM.

As used above, the term “block” is used to refer to any type of unit in a virtual machine image. For instance, a block can be variable length units defined by hashes, or disk units such as sectors or tracks, or units of a file system (e.g., file system blocks or files and directories), or any other unit by which a virtual machine image can be accessed and managed in discrete parts.

### CONCLUSION

Embodiments, processes, and features discussed above can be realized in the form of information stored in volatile or non-volatile computer or device readable storage media. This is deemed to include at least media such as optical storage (e.g., compact-disk read-only memory (CD-ROM)), magnetic media, flash read-only memory (ROM), or any current or future means of storing digital information in a form convenient for operating a processor. The stored information can be in the form of machine executable instructions (e.g., compiled executable binary code), source code, bytecode, encrypted code, or any other information that can be used to enable or configure computing devices to perform the various embodiments discussed above. This is also deemed to include at least volatile memory such as random-access memory (RAM) and/or virtual memory storing information such as central processing unit (CPU) instructions during execution of a program carrying out an embodiment, as well as non-volatile media storing compilable or interpretable source code in a programming language, as well as information (e.g., CPU instructions) that can be directly loaded and executed by a computer. The embodiments and features can be performed on any type of computing device, including portable devices, workstations, servers, mobile wireless devices, and so on, although generally, verification may be practical on server-grade hardware.

1. A method of composing a virtual machine image from a base virtual machine image and one or more applications to be composed with the base virtual machine image, the method comprising:
inserting the one or more applications into the base virtual machine image to generate a composite virtual machine image, wherein the base virtual machine image, prior to the inserting, contains a guest operating system and is bootable as a virtual machine to execute the guest operating system, and wherein prior to the inserting there exists a base signature of the base image comprised of a plurality of base block signatures of respective base blocks of the base virtual machine image; and
generating a signature of the composite virtual machine image, the signature comprised of a subset of the base block hashes and comprised of application block hashes of respective blocks of the composite virtual machine image that contain portions of the inserted applications.

2. A method according to claim 1, wherein the base block hashes are computed in advance prior to the inserting, and the method further comprises identifying the application blocks and computing the application block hashes thereof.

3. A method according to claim 1, wherein at least some of the application block hashes are computed prior to the inserting.

4. A method according to claim 1, further comprising:
receiving the composite virtual machine image and the signature of the virtual machine image at a server with a virtualization layer that manages execution of virtual machines on the server;
executing the composite virtual machine image within a virtual machine managed by the virtualization layer;
verifying the received signature against the received composite virtual machine image by starting execution of the virtual machine while blocks of the composite virtual machine image have not been verified, and verifying blocks of the composite virtual machine image while the virtual machine is executing by computing hashes of the blocks being verified.

5. A method according to claim 4, further comprising determining when an unverified block is needed for execution of the virtual machine and in response verifying the unverified block by computing a hash thereof and comparing it to a corresponding hash in the signature of the composite virtual machine image.

6. A method according to claim 1, further comprising:
storing a copy of the base signature on a server prior to receiving the composite virtual image at the server, the server comprising a virtual machine manager that manages virtual machines on the server; and
computing a local signature of the received copy of the composite base virtual machine image using at least some of the base block hashes.

7. A method according to claim 6, wherein the computing the local signature is performed without calculating hashes of at least some blocks of the copy of the composite base virtual machine, and wherein the local signature verifies the entire copy of the composite base virtual machine image.

8. One or more computer readable storage storing information to enable a computer to perform a process, the process comprising:
accessing a library of software packages and selecting a set of the software packages;
accessing a library of base virtual machine images having respective pre-computed signatures and selecting a base virtual machine image;
building a new virtual machine image comprised of the selected set of software packages and comprised of original blocks of the selected base virtual machine image and blocks containing parts of the software packages; and
computing a first signature of the new virtual machine image using at least part of the pre-computed signature of the selected base virtual machine image.

9. One or more computer-readable storage according to claim 8, wherein the computed signature comprises hashes of blocks of the selected base virtual machine image and hashes of blocks that contain portions of the selected set of software packages, the process further comprising:
receiving the first signature and the new virtual machine image at a server with a virtualization layer that manages execution of virtual machines on the server;
computing a second signature by computing hashes of blocks of the received new virtual machine image that contain portions of the selected application packages and not computing hashes of blocks that do not contain portions of the selection application packages; and
verifying the received new virtual machine image by determining that the first signature matches the second signature.

10. One or more computer-readable storage according to claim 9, the process further comprising storing a signature of the selected base virtual image and using hashes of the stored signature to compute the second signature.

11. One or more computer-readable storage according to claim 8, the process further comprising executing the received virtual machine image as a virtual machine, and allowing a block of the virtual machine image to be loaded only if the block has been verified according to a hash thereof.

12. One or more computer-readable storage according to claim 11, the process further comprising computing hashes of blocks of the new virtual machine image in parallel with execution of the virtual machine according to the new virtual machine image.

13. One or more computer-readable storage according to claim 8, the process further comprising installing the software packages into the new virtual machine image such that the software thereof is in a state ready for execution, identifying blocks of the new virtual machine image that contain the installed software, and using a variable block length hashing algorithm to compute new hashes of the identified blocks, wherein the new virtual machine image comprises at least some original blocks that contain only data of the selected base virtual machine image, wherein the part of the pre-computed signature of the selected base virtual machine image comprises hash values of the original blocks that are used, and wherein the first signature is computed using hash values of the pre-computed signature without hashing the original blocks of the new virtual machine image.

14. A method of verifying a virtual machine disk image received at a server that hosts virtual machines in which respective guest operating systems execute, the virtual machine disk image having software installed therein, the virtual machine having been created by installing the software on a base virtual machine disk image, the method comprising:
executing a virtual machine manager on the server;
computing a signature of the entire virtual machine image received at the server using pre-computed hashes of blocks of the base virtual machine image that also exist in the virtual machine image and by computing hashes of blocks that contain the installed software, wherein the computing is performed by the virtual machine manager.

15. A method according to claim 14, the method further comprising comparing the computed signature with a received signature to determine that the received virtual machine disk image is valid.

16. A method according to claim 14, wherein the virtual machine image comprises a differencing disk comprised of a parent disk image and a chain of difference disk images.

17. A method according to claim 16, wherein the parent disk image and the difference disk images each have respective hashes, and the differencing disk is verified by verifying the hashes of the difference disk images, the method further comprising verifying blocks of the differencing disk as they are needed by the virtual machine manager using hashes of the corresponding difference disk images.

18. A method according to claim 14, further comprising using a signature of the base virtual machine disk image to compute the signature of the received virtual machine disk image.

19. A method according to claim 14, wherein code page sharing or transparent page sharing is used by the virtual machine manager and the virtual machine manager only verifies the hashes for respective shared pages one time, the code page sharing or transparent page sharing allowing two different virtual machines to share a same page in a same portion of memory.

20. A method according to claim 14, wherein the server includes a hardware encryption module and the virtual machine manager uses the hardware encryption module to accelerate computing of hashes.
